(19) United States
(12) Patent Application Publication
(10) Pub. No.: US 2020/0038982 A1
(43) Pub. Date: Feb. 6, 2020

(54) DISRUPTING AFFINITY BETWEEN METALLIC SPHERES

(71) Applicant: Seagate Technology LLC, Cupertino, CA (US)

(72) Inventors: Jonathan Paul Robelia, Richfield, MN (US); Paul Davidson, Eden Prairie, MN (US); Amy Jo Bergerud, Minneapolis, MN (US)

(21) Appl. No.: 16/051,682

(22) Filed: Aug. 1, 2018

(51) Int. Cl. B23K 3/06

(52) U.S. Cl. CPC B23K 3/0623

(57) ABSTRACT

Implementations described and claimed herein address the foregoing problems by providing a soldering method including mixing a plurality of spheres in a bond-head hopper wherein a first number of the plurality of the spheres have a diameter that is at least fifty (50) percent larger than the rest of the plurality of spheres.

### BACKGROUND

Data-storage devices using various kinds of media, such as optical disks, magnetic-recording disks, magneto-optical disks, and similar disks for data-storage devices are known in the art. In particular, hard disk drives (HDDs) have been widely used as data-storage devices that have proven to be indispensable for contemporary computer systems. Moreover, HDDs have found widespread application to motion picture recording and reproducing apparatuses, car navigation systems, digital cameras, cellular phones, and similar devices, in addition to computers, due to their outstanding information-storage characteristics. An HDD includes a head-slider for accessing a magnetic-recording disk and an actuator for supporting the head-slider and rotating the head-slider in proximity to the recording surface of the magnetic-recording disk. The actuator includes a suspension to which the head-slider is affixed. The lift generated by the airflow between the head-slider and the spinning magnetic-recording disk balances the force applied to the head-slider by the suspension to allow the head-slider to fly in proximity to the recording surface of the magnetic-recording disk.

Solder-ball bonding (SBB) (or solder-sphere bonding) is a method for electrically interconnecting a slider with the transmission lines of the suspension. An SBB method disposes solder balls between connection pads of a head-slider and connection pads of a suspension and performs a reflow process with a laser beam to electrically interconnect the connection pads of the head-slider and the connection pads of the suspension. The solder balls undergo a reflow process within an atmosphere of an inert gas such as nitrogen to prevent the solder surfaces from being oxidized. To melt a solder ball disposed between two connection pads by a reflow process with a laser beam, the solder ball must be correctly disposed between the pads. However, a head-slider is a tiny component and further miniaturization of the head-slider is under development. Consequently, connection pads and solder balls disposed on the head-slider are becoming smaller so that disposing solder balls at the proper locations for soldering is becoming progressively more difficult.

### SUMMARY

Implementations described and claimed herein address the foregoing problems by providing a soldering method including mixing a plurality of spheres wherein a first number of the plurality of the spheres have a diameter that is at least fifty (50) percent larger than the rest of the plurality of spheres.

These and various other features and advantages will be apparent from a reading of the following detailed description.

### BRIEF DESCRIPTIONS OF THE DRAWINGS

A further understanding of the nature and advantages of the various implementation disclosed herein may be realized by reference to the figures, which are described in the remaining portion of the specification.

FIG. 1 illustrates an example block diagram of a bond-head hopper according to an implementation disclosed herein.

FIG. 2 illustrates an example block diagram of a bond-head hopper assembly according to an implementation disclosed herein.

FIG. 3 illustrates an example graph of bonding cycle time for a bond-head hopper according to an implementation disclosed herein.

### DETAILED DESCRIPTIONS

Reference will now be made in detail to the alternative embodiments of the present technology disclosed herein. While the technology will be described in conjunction with the alternative embodiments, it will be understood that they are not intended to limit the invention to these embodiments. On the contrary, the invention is intended to cover alternatives, modifications and equivalents, which may be included within the spirit and scope of the invention as defined by the appended claims.

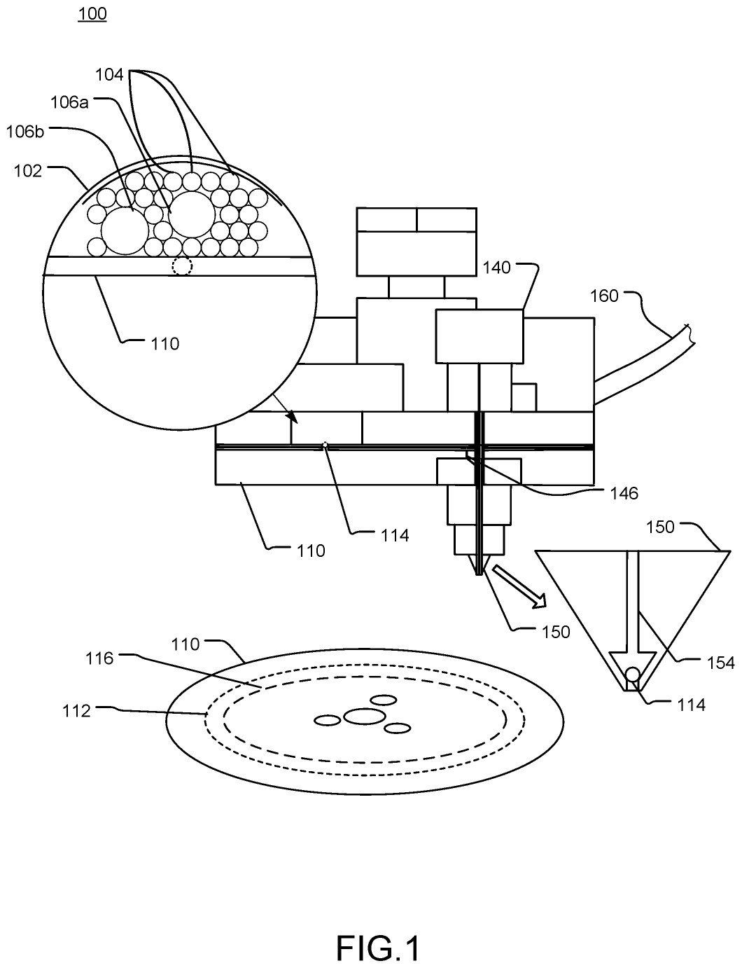

FIG. 1 illustrates a block diagram of a soldering apparatus 100 of a bond-head hopper 102 according to an implementation disclosed herein. The soldering apparatus is configured to melt solder-spheres with a laser beam before ejecting the solder-spheres between pads for soldering. The soldering apparatus 100 includes a bond-head hopper 102 that may be configured to hold a plurality of solder spheres 104 and larger spheres 106. In one implementation the bond-head hopper 102 may be approximately 750 um (microns) wide. A solder-sphere is conveyed from a sphere dispenser, also referred to as a bond-head hopper 102, to a capillary 150 using a singulation disk 110. The singulation disk 110 may have a plurality of holes 112 arranged in a circular pattern. A plurality of index holes 116 may be used to position the singulating disk 110.

A singulation disk 110 may be configured at the bottom of the bond-head hopper 102 such that the solder spheres 104 and larger spheres 106 are constantly in contact with the singulation disk 110 and the solder spheres 104 tumble into the holes 112 of the singulation disc 110. This is illustrated by a solder sphere 114 dropping on the singulation disk 110. The singulation disk 110 is used for singulating the solder spheres from the bond-head hopper 102 into the capillary 150. The singulation disk rotates around its axis with the solder spheres in the openings 112. The singulation disk 112 is also configured to drop the solder spheres from the openings 112 into a drop chute 146 into the capillary 150.

A laser 140 is configured above the capillary 150 such that a laser signal is directed onto the solder sphere 114 when it is in the capillary 150. The laser signal melts the solder sphere 114 at a desired location to create a soldered bond between a suspension circuit of a head-gimbal assembly (HGA) and a slider. In one implementation, the solder sphere 114 may be pressurized through the capillary 150 via a nitrogen (N₂) supply 160. The solder sphere 114 falls via the drop chute 146 into the capillary 150. Once the pressure from the nitrogen supply 160 reaches a predetermined threshold, it initiates the laser to be targeted on the solder sphere 114 at the end of the capillary 150. The laser energy results in melting of the solder sphere 114 and the melted solder sphere 114 jets out where the solder join between the suspension circuit of a head-gimbal assembly (HGA) and a slider is to be formed.

As the size of the HGA assembly gets smaller and smaller, the solder spheres used to form the solder joint also gets smaller. Using solder spheres of increasingly smaller diameter results in the solder spheres bridging and clumping in the bond-head hopper 102. Solder bridging results from the smaller solder spheres causing a bridge or arch on top of the hole at the bottom where the solder sphere exits towards the singulating disk. Such bridging and clumping results in significant downtime for the soldering apparatus 100.

For example, when the diameter of the solder spheres is in the range of 40 um or 45 um, the soldering apparatus 100 may not maintain its units per hours (UPH) requirement through a complete work day. Furthermore, such bridging and clumping of the solder-spheres in the bond-head hopper 102 also results in more bond-head service calls and therefore reducing the bond-head life (time between bond-head service calls).

In one implementation disclosed herein, the bond-head hopper 102 is configured to include some solder spheres that have a diameter that is significantly higher than diameter of the rest of the plurality of solder spheres. For example, FIG. 1 shows that some spheres 106a, 106b (together referred to as the larger spheres 106) have significantly higher diameter compared to the diameter of the other smaller spheres 104. Furthermore, the diameters of the larger spheres 106 may also vary in that the diameter of the sphere 106a may be different than the diameter of the sphere 106b. For example, the diameter of the smaller solder spheres 104 may be approximately 50 um while the diameter of the larger spheres 106 may have a diameter at least twice as large as the diameter of the smaller solder spheres 104. For example, in one implementation, the diameter of the larger spheres 106 may be at least 100 um. However, in an alternative implementation, the diameter of the larger spheres 106 may be as large as 200 um.

Providing the combination of solder spheres 104 and larger spheres 106 in the bond-head hopper 102 results in reduced amount of clumping and bridging between the smaller solder spheres 104 in the bond-head hopper 102, which results in increased bond-head life and increased UPH. In one implementation, the combination of solder spheres 104 and larger spheres 106 is maintained such that approximately half of the volume of the solder spheres in the bond-head hopper is made of larger spheres 106.

The solder spheres 104 and the larger spheres 106 may be made of a combination of metals. In one implementation, the larger spheres 106 may be made of material other than the solder material. Examples of such alternative material are nickel, tungsten carbide, tungsten, etc. In one implementation, the material of the larger spheres 106 is made of a material that is of equal or greater density than the density of the solder spheres 104. In one implementation, the solder spheres 104 and larger spheres 106 may be made of combination of tin, silver, and copper. In one implementation, the larger spheres 106 are not harder than the solder spheres 104.

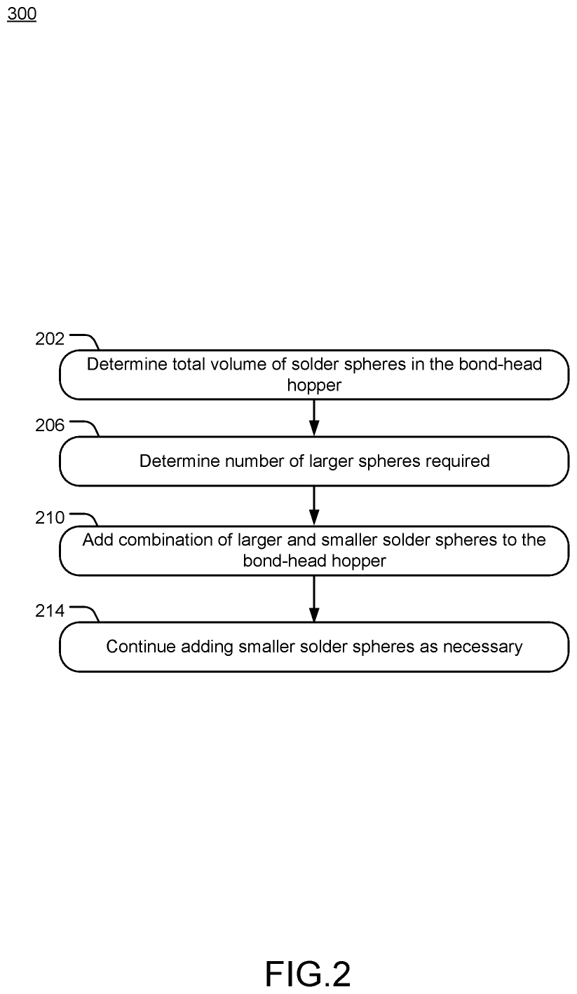

FIG. 2 illustrates a flowchart 200 of the method of soldering disclosed herein. An operation 202 determines the total volume of solder spheres that can be used in the bond-head hopper. An operation 206 determines the number of larger diameter spheres that need to added to the bond-head hopper. In one implementation, the larger diameter spheres may be made of material other than the solder material. In one implementation, the determining operation 206 may determine the number of larger diameter spheres to ensure that the bond-head hopper has approximately the same volume of larger diameter spheres and smaller diameter solder spheres. An operation 210 adds the combination of the larger diameter spheres and the smaller solder spheres to the bond-head hopper. Subsequently, the number of larger diameter spheres in the bond-head hopper may remain constant and an operation 214 may continue adding smaller diameter solder spheres to the bond-head hopper at a continuous rate as necessary.

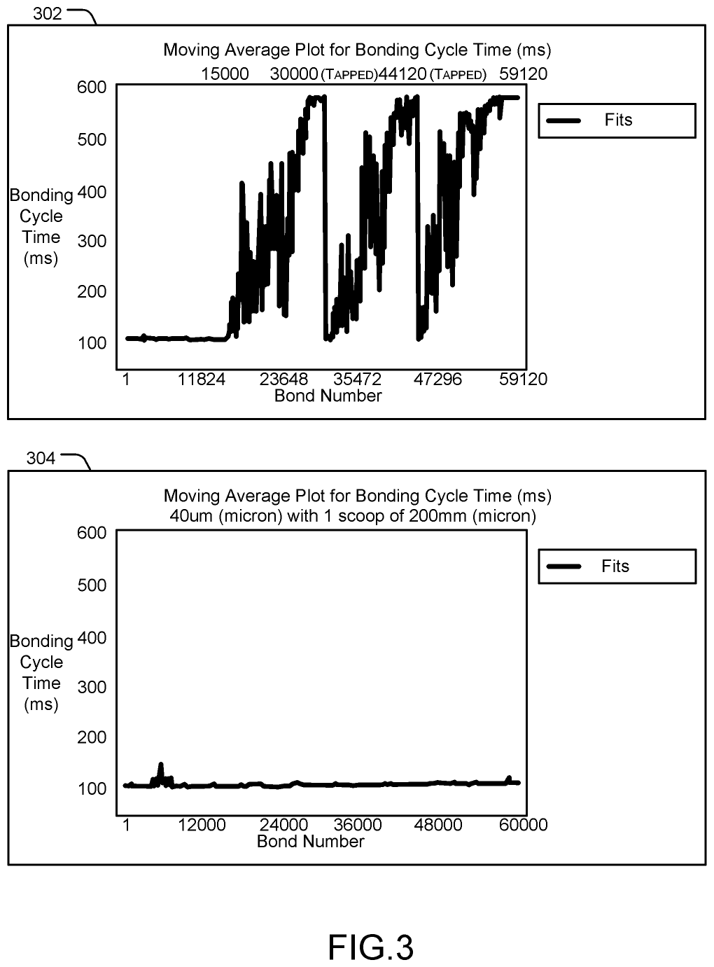

FIG. 3 illustrates graphs of bonding cycle time for a bond-head hopper according to an implementation disclosed herein. Specifically, the graph 302 discloses bonding cycle times in milli-seconds (ms) on the y-axis for only 40 um solder spheres in the bond-head hopper. Thus, all solder spheres are of the same diameter. As shown, the bonding cycle times are about 100 ms for about first 15,000 solder spheres and after that the average bonding cycle times increases due to bridging and clumping issues in the bond-head hopper. The average bonding cycle times rises to as much as 600 ms at about 30,000 solder spheres, when the bond-head has to be serviced. Thus, the bond-head life is about 30,000 spheres bonded.

The graph 304 discloses average bonding cycle times in milli-seconds (ms) on the y-axis for a soldering apparatus where the bond-head hopper has solder spheres with diameter of 40 um mixed with solder spheres having significantly higher diameter. As seen therein, the bonding cycle times are about 100 ms for as much as up to 60,000 solder spheres bonded with only a few variations or spikes in the average overall bonding cycle times. In this implementation, the number of solder spheres with larger diameter makes up about half of the volume of the total volume of the solder spheres in the bond-head hopper.

In one implementation, the bond-head hopper has about 16,000 solder spheres with a diameter that is substantially higher than the remaining solder spheres being approximately 250,000. In such an implementation, the solder spheres with the higher diameter may have diameter of approximately at least fifty (50) percent higher than diameter of rest of the plurality of solder spheres. For example, the larger solder spheres may have a diameter of 200 μm whereas the smaller solder spheres may have a diameter of 50 μm. Alternatively, the larger solder spheres may have a diameter of 250 μm whereas the smaller solder spheres may have a diameter of 40 μm. In one implementation, the solder spheres with larger diameter form approximately half the volume of the total volume of the solder spheres in the bond-head hopper.

The above specification, examples, and data provide a complete description of the structure and use of example implementations. Since many implementations of the invention can be made without departing from the spirit and scope of the invention, the invention resides in the claims hereinafter appended. Furthermore, structural features of the different implementations may be combined in yet another implementation without departing from the recited claims. The implementations described above, and other implementations are within the scope of the following claims.

What is claimed is:

1. A method, comprising:
mixing a plurality of spheres;
wherein a first number of the plurality of the spheres have a diameter that is at least fifty (50) percent larger than diameter of rest of the plurality of spheres.

2. The method of claim 1, wherein the first number of the plurality of the spheres form approximately at least ten (10) percent the volume of the total volume of the plurality of the spheres.

3. The method of claim 1, wherein the diameter of the first number of the plurality of the spheres is at least 100 μm whereas the diameter of the rest of the plurality of spheres is less than 50 μm.

4. The method of claim 1, wherein the diameter of the first number of the plurality of the solder spheres is at least 200 μm whereas the diameter of the rest of the plurality of solder spheres is less than 40 μm.

5. The method of claim 1, further comprising determining the number of the first number of the plurality of the solder spheres to be added to a bond-head hopper.

6. The method of claim 5, wherein determining the number of the first number of the plurality of the spheres further comprises determining the number of the first number of the plurality of the spheres that results in the first number of the plurality of the spheres forming approximately at least ten percent (10) of the volume of the total volume of the bond-head hopper.

7. The method of claim 1, wherein the first number of spheres is greater than approximately 16,000 and number of the rest of the plurality of spheres are approximately 250,000.

8. The method of claim 1, wherein the first number of the plurality of the spheres are made of a material that is not a solder metal and the rest of the plurality of spheres are solder spheres.

9. The method of claim 1, wherein the first number of the plurality of the spheres include spheres of at least two substantially different diameters.

10. A soldering apparatus, comprising:
A bond-head hopper configured to receive a plurality of spheres, wherein a first number of the plurality of the spheres have a diameter that is at least fifty (50) percent higher than the rest of the plurality of spheres; and
a singulation disk configured to dispense one or more of the rest of the plurality of spheres to a capillary of the soldering apparatus.

11. The soldering apparatus of claim 10, wherein the diameter of the first number of the plurality of the spheres is at least 100 um whereas the diameter of the rest of the plurality of spheres is less than 50 um.

12. The soldering apparatus of claim 10, wherein the first number of the plurality of the spheres form approximately at least ten (10) percent the volume of the total volume of the plurality of the spheres in the bond-head hopper.

13. The soldering apparatus of claim 10, wherein the diameter of the first number of the plurality of the spheres is at least 200 um whereas the diameter of the rest of the plurality of spheres is less than 40 um.

14. The soldering apparatus of claim 10, wherein the apparatus is further configured to determine the number of the first number of the plurality of the spheres to be added to the bond-head hopper.

15. The soldering apparatus of claim 14, wherein the apparatus is further configured to determine the number of the first number of the plurality of the spheres to be added to the bond-head hopper so that the first number of the plurality of the spheres forming approximately at least twenty-five (25) percent the volume of the total volume of spheres in the bond-head hopper.

16. The soldering apparatus of claim 10, wherein the first number of spheres is greater than approximately 16,000 and number of the rest of the plurality of spheres are approximately 250,000.

17. The soldering apparatus of claim 10, wherein the first number of the plurality of the spheres have a diameter that is at least one hundred (100) percent higher than diameter of rest of the plurality of solder spheres.

18. The soldering apparatus of claim 10, wherein the first number of the plurality of the spheres include spheres of at least two substantially different diameters.

19. The soldering apparatus of claim 10, wherein the first number of the plurality of the spheres are made of a material that is not a solder metal and the rest of the plurality of spheres are solder spheres.

20. The soldering apparatus of claim 10, wherein the first number of the plurality of the spheres are made of a material that is no harder than the material of the rest of the plurality of spheres.
